(19) United States
(12) Patent Application Publication
(10) Pub. No.: US 2025/0149736 A1
(43) Pub. Date: May 8, 2025

(54) SEPARATOR, METHOD FOR MANUFACTURING THE SAME, AND ELECTROCHEMICAL DEVICE INCLUDING SEPARATOR

(71) Applicants: SK INNOVATION CO., LTD., Seoul (KR); SK IE TECHNOLOGY CO., LTD., Seoul (KR)

(72) Inventors: Chang Hee LEE, Daejeon (KR); Sang Hoon KIM, Daejeon (KR); Sang Yoon JI, Daejeon (KR)

(21) Appl. No.: 18/935,652

(22) Filed: Nov. 4, 2024

(30) Foreign Application Priority Data
Nov. 3, 2023 (KR) 10-2023-0150437

(51) Int. Cl. H01M 50/446; H01M 50/403; H01M 50/42; H01M 50/449

(52) U.S. Cl. CPC H01M 50/446; H01M 50/403; H01M 50/42; H01M 50/449

(57) ABSTRACT

Provided are a separator, a method for manufacturing the same, and an electrochemical device including the separator. According to an embodiment of the present disclosure, a separator is provided which includes a porous substrate; and an inorganic particle layer which is formed on at least one surface of the porous substrate and includes a binder and inorganic particles, wherein the binder includes a first water-soluble polymer including a metal carboxylate group and a second water-soluble polymer based on (meth)acrylamide.

### CROSS-REFERENCE TO RELATED APPLICATIONS

This application claims priority under 35 U.S.C. § 119 to Korean Patent Application No. 10-2023-0150437, filed on Nov. 3, 2023, the disclosure of which is incorporated herein by reference in its entirety.

### TECHNICAL FIELD

Embodiments of the present disclosure relate generally to a separator for an electrochemical device, a method for manufacturing the same, and an electrochemical device including the separator.

### BACKGROUND

In recent years, as demand for environmentally friendly technologies has rapidly increased, research on various renewable or improved energy sources has also increased substantially. Use of lithium secondary batteries as a power supply for mobile devices such as smart phones and laptops or electric vehicles has increased dramatically due to its advantages of high energy density and small self-discharge.

The lithium secondary battery uses an electrolyte including a lithium salt and a non-aqueous solvent, and the non-aqueous solvent requires to have high permittivity for dissolving a lithium salt and high ion conductivity in a large temperature range.

In order to satisfy the demand, a mixture of cyclic carbonates represented by propylene carbonate, ethylene carbonate, and the like and linear carbonates represented by dimethyl carbonate, diethyl carbonate, and the like are used as the non-aqueous solvent.

However, though the electrolyte including a lithium salt and a carbonate-based mixed solvent as such shows excellent battery performance due to ion conductivity, the electrolyte has a limitation because it can be subjected to hydrolysis by reacting with even very small traces of moisture present in the electrolyte. Decomposition products occurring during a hydrolysis process, such as HF and PO₃F²⁻, may further serve as a catalyst of a decomposition reaction, and may also affect corrosion of the active material, thus causing decreased battery capacity and battery swelling due to gassing.

Heretofore, a general solution for inhibiting electrolyte decomposition has been to introduce an electrolyte additive. However, the known electrolyte additives besides being expensive, are also sensitive to moisture, are difficult to store, and may adversely affect cell performance. These electrolyte additives typically are in a form that dissolves in the electrolyte. As an example, conventional technology describes a lithium secondary battery using a certain alkali metal salt as the electrolyte additive.

Because of these issues and especially because the electrolyte additives may adversely affect cell performance, a solution for a lithium secondary battery which may inhibit electrolyte decomposition reactions more effectively is needed.

### SUMMARY

An embodiment of the present disclosure overcomes the aforementioned issues associated with conventional art electrochemical devices. An embodiment of the present disclosure provides a separator for an electrochemical device which may effectively inhibit electrolyte decomposition reaction to improve performance of the electrochemical device using the separator. Other embodiments of the present disclosure also provide a method for manufacturing the separator same, and an electrochemical device including the separator.

Another embodiment of the present disclosure provides a separator which significantly inhibits the electrolyte decomposition reaction and also has excellent heat resistance and adhesion.

Another embodiment of the present disclosure provides a new separator inhibiting electrolyte decomposition when being assembled into a battery, which includes a porous substrate and an inorganic particle layer having pores formed between inorganic particles by the inorganic particles being connected to each other, and a method for manufacturing the same.

Still other embodiments of the present disclosure provide a new separator which may improve performance of an electrochemical device by effectively inhibiting an electrolyte decomposition reaction inside a battery by action of a binder, by designing the binder which connects and fixes inorganic particles to each other in an inorganic particle layer of the separator when manufacturing a battery using the separator, a method for manufacturing the same, and an electrochemical device including the separator.

According to an embodiment of the present disclosure, a separator includes a porous substrate; and an inorganic particle layer which is formed on at least one surface of the porous substrate and includes a binder and inorganic particles, wherein the binder includes a first water-soluble polymer including a metal carboxylate group and a second water-soluble polymer based on (meth)acrylamide.

In the separator according to an embodiment, the first water-soluble polymer may be one or more selected from the group consisting of polyacrylic acid metal salts, carboxymethyl cellulose metal salts, and alginic acid metal salts, and the metal may include alkali metals, alkaline earth metals, or combinations thereof.

In the separator according to an embodiment, the first water-soluble polymer may have a weight average molecular weight of 2,000 to 100,000 g/mol.

In the separator according to an embodiment, the separator may include 1 to 20 parts by weight of the first water-soluble polymer with respect to 100 parts by weight of the inorganic particles.

In the separator according to an embodiment, the second water-soluble polymer may include poly(meth)acrylamide or a copolymer including the same.

In the separator according to an embodiment, the copolymer may be a copolymer including a (meth)acrylamide-based monomer polymerization unit; and a hydroxyl group-containing (meth)acrylate-based monomer polymerization unit, a polyfunctional (meth)acrylamide-based monomer polymerization unit, or a combination thereof.

In the separator according to an example embodiment, the second water-soluble polymer may have a weight average molecular weight of 100,000 to 2,000,000 g/mol.

In the separator according to an embodiment, the separator may include 0.1 to 10 parts by weight of the second water-soluble polymer with respect to 100 parts by weight of the inorganic particles.

In the separator according to an embodiment, the separator may have heat shrinkage rates in MD and TD of 2% or less as measured after being allowed to stand at 150° C. for 60 minutes.

According to another embodiment of the present disclosure, a method for manufacturing a separator includes preparing a slurry composition including a binder and inorganic particles; and applying the slurry composition on at least one surface of a porous substrate to form an inorganic particle layer, wherein the binder includes a first water-soluble polymer including a metal carboxylate group and a second water-soluble polymer based on (meth)acrylamide.

In the method for manufacturing a separator according to an embodiment, the first water-soluble polymer may be one or more selected from the group consisting of polyacrylic acid metal salts, carboxymethyl cellulose metal salts, and alginic acid metal salts, and the metal may include alkali metals, alkaline earth metals, or combinations thereof.

In the method for manufacturing a separator according to an embodiment, the first water-soluble polymer may have a weight average molecular weight of 2,000 to 100,000 g/mol.

In the method for manufacturing a separator according to an embodiment, the second water-soluble polymer may be polyacrylamide or a copolymer including the same.

In the method for manufacturing a separator according to an embodiment, the copolymer may be a copolymer including a (meth)acrylamide-based monomer polymerization unit; and a hydroxyl group-containing (meth)acrylate-based monomer polymerization unit, a polyfunctional (meth)acrylamide-based monomer polymerization unit, or a combination thereof.

In still another embodiment of the present disclosure, an electrochemical device is provided which includes the separator as described above.

Other features and aspects will become apparent to those with ordinary skill in the art from the following detailed description, the drawings, and the claims.

### DETAILED DESCRIPTION

The embodiments described in the present specification may be modified in many different forms, and the technology according to the embodiments t limited to the descriptions set forth herein. In addition, the embodiments are provided so that the scope of the present disclosure will be described in more detail to a person with ordinary skill in the art.

In addition, a singular form used in the specification and claims appended thereto may be intended to include a plural form also, unless otherwise indicated in the context.

In addition, a numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in this specification, values which may be outside a numerical range due to experimental error or rounding of a value are also included in the defined numerical range.

Furthermore, throughout this specification, unless explicitly described to the contrary, “including” or “comprising” any constituent elements will be understood to imply further inclusion of other constituent elements rather than exclusion of other constituent elements.

In the present specification, it will be understood that when an element such as a layer, film, region, or substrate is referred to as being “on” or “above” another element, it can be “directly on” the other element or intervening elements may also be present.

The terms such as “first” and “second” used in the present specification may be used to describe various constituent elements, but the constituent elements are not to be limited to the terms. The terms are only used to differentiate one constituent element from other constituent elements.

“Monomer polymerization unit” used in the present specification may refer to a basic repeating unit in a polymer chain that originates from the monomer.

In the present specification, “(meth)acryl” refers to acryl and/or methacryl.

“Substituted” in the expression “substituted or unsubstituted” in the present specification means that one or more hydrogen atoms in a hydrocarbon are independently of each other replaced with the same or a different substituent. A non-limiting example of the substituent may include deuterium, a halogen group, a hydroxyl group, an amino group, a C1 to C30 amine group, a nitro group, a C1 to C30 silyl group, a C1 to C30 alkyl group, a C1 to C30 alkylsilyl group, a C3 to C30 cycloalkyl group, a C1 to C30 heterocycloalkyl group, a C6 to C30 aryl group, a C1 to C30 heteroaryl group, a C1 to C20 alkoxy group, a C1 to C10 trifluoroalkyl group, or a cyano group.

“Dn”, where n is a real number, in the present specification refers to a particle diameter of a particle which is equivalent to no in terms of a volume-based integrated fraction. For example, “D50” refers to a particle diameter of a particle which is equivalent to 50% in terms of a volume-based integrated fraction. Dn may be derived from particle size distribution results obtained by collecting a sample of inorganic particles to be measured in accordance with the standard of KS A ISO 13320-1 and performing analysis using Multisizer 4e Coulter counter available from Beckman coulter.

A conventional method for inhibiting electrolyte decomposition of a battery is mainly adding an additive as one component in an electrolyte, however existing additives are moisture sensitive, difficult to store, expensive, and may dissolve in the electrolyte which in turn may negatively affect cell performance.

It has been found based on extended research that when a separator which includes both a polymer using a metal carboxylate salt as a functional group and a (meth)acrylamide-based polymer as a binder is used in a battery, electrolyte decomposition may be inhibited while overcoming the limitations of existing separators described above.

That is, the separator including an inorganic particle layer including the binder according to the present disclosure may effectively inhibit the electrolyte decomposition reaction, improve the performance of an electrochemical device without deterioration, and also, simultaneously secure excellent heat resistance and adhesion, by designing a specific polymer combination. In addition, a battery having a characteristic of significantly decreasing changes such as volume expansion of an electrochemical device over time may be provided, and also, an effect of having a significantly excellent life characteristic by reduced resistance of a battery may be provided.

The embodiments of the present disclosure provide a novel, improved separator which can effectively inhibit an electrolyte decomposition reaction to improve performance of an electrochemical device, a method for manufacturing the same, and an electrochemical device including the separator.

The separator according to an embodiment includes a porous substrate; and an inorganic particle layer which is formed on at least one surface of the porous substrate and includes a binder and inorganic particles wherein the binder includes a first water-soluble polymer including a metal carboxylate group and a second water-soluble polymer based on a (meth)acrylamide. Herein, the (meth)acrylamide-based polymer refers to a polymer including a (meth)acrylamide-based monomer polymerization unit.

Since the separator includes a mixed binder including the first water-soluble polymer and the second water-soluble polymer, the electrolyte decomposition reaction is effectively inhibited while solving a conventional problem due to an electrolyte decomposition inhibitor added to an electrolyte, thereby significantly improving performance of an electrochemical device such as a lithium secondary battery.

Specifically, since the mixed binder including the first water-soluble polymer including a metal carboxylate group and the second water-soluble polymer based on (meth)acrylamide is used as the binder, the binder provides a water-based separator which is stable in moisture and environmentally friendly. Since the separator according to an embodiment includes the binder described above, electrolyte decomposition inside the separator may be inhibited to inhibit a side reaction which additionally occurs. In addition, the separator significantly inhibits the electrolyte decomposition reaction, and also has both excellent heat resistance and adhesion. The electrochemical device using an electrolyte decomposition inhibitor added to the electrolyte has a disadvantage in which the electrolyte decomposition inhibitor is dissolved in an electrolyte to adversely affect cell performance. However, in the electrochemical device according to an embodiment, the binder included in the separator is not dissolved in the electrolyte, thereby solving the conventional problem in which the electrolyte decomposition inhibitor is dissolved in the electrolyte which adversely affects cell performance. Since the electrochemical device may inhibit electrolyte decomposition while solving the conventional problem as such, it may have excellent resistance and life characteristics.

Hereinafter, each constituent of the separator according to an embodiment of the present disclosure will be described.

In an embodiment, the first water-soluble polymer is a polymer including a metal carboxylate group. The first water-soluble polymer including a metal carboxylate group may be obtained by using a polymer or copolymer in which a metal carboxylate group is present or introduced as appropriate polymerization unit(s) bearing the metal carboxylate group.

The first water-soluble polymer is not particularly limited. Without being bound to any theory, it may be believed that since the first water-soluble polymer includes the metal carboxylate group which may contribute to exert a electrolyte decomposition inhibitory effect, without the polymer-bound group however being soluble in the electrolyte, a main chain and/or a side chain is not particularly limited as long as it includes a metal carboxylate group. For example, the first water-soluble polymer may be one or more selected from the group consisting of polyacrylic acid metal salts, carboxymethyl cellulose metal salts, and alginic acid metal salts.

In an embodiment, the metal of the metal carboxylate group may include an alkali metal, an alkaline earth metal, or a combination thereof, and specifically, may be sodium or lithium.

In an embodiment, the first water-soluble polymer may have a weight average molecular weight in terms of polyethylene glycol of 2,000 g/mol or more, 3,000 g/mol or more, 100,000 g/mol or less, 50,000 g/mol or less, 40,000 g/mol or less, 30,000 g/mol or less, 15,000 g/mol or less, or a value between the numerical values, as measured using gel permeation chromatography. Specifically, the first water-soluble polymer may have the weight average molecular weight of 2,000 to 100,000 g/mol, 2,000 to 50,000 g/mol, 3,000 to 40,000 g/mol, 3,000 to 30,000 g/mol, or 3,000 to 15,000 g/mol.

The separator according to an embodiment may have further improved electrolyte decomposition inhibition characteristic, heat resistance, and adhesion, when the weight average molecular weight of the first water-soluble polymer satisfies the above range.

In an embodiment, the separator may include the first water-soluble polymer at 1 part by weight or more, 2 parts by weight or more, 5 parts by weight or more and 20 parts by weight or less, 15 parts by weight or less, or a value between the numerical values, with respect to 100 parts by weight of the inorganic particles. Specifically, the separator may include 1 to 20 parts by weight, 2 to 15 parts by weight, or 5 to 15 parts by weight of the first water-soluble polymer, with respect to 100 parts by weight of the inorganic particles. The separator according to an embodiment may have further improved electrolyte decomposition inhibition characteristic, heat resistance, and adhesion, when the content of the first water-soluble polymer satisfies the above range.

In a preferred embodiment, the separator may include 1 to 10 parts by weight or 1 to 9 parts by weight or 2 to 8 parts by weight of the first water-soluble polymer, with respect to 100 parts by weight of the inorganic particles. When the content of the first water-soluble polymer satisfies the above range, the separator may be applied to a battery having better performance.

Since the separator according to an embodiment includes the second water-soluble polymer based on the (meth)acrylamide-based together with the first water-soluble polymer, the electrolyte decomposition reaction may be effectively inhibited, adhesion between the porous substrate and the inorganic particle layer may be increased, and heat resistance at a high temperature may be improved.

The second water-soluble polymer based on (meth)acrylamide may be a homopolymer or a copolymer. The second water-soluble polymer based on (meth)acrylamide may be a homopolymer or a copolymer in which a (meth)acrylamide is used as polymerization unit(s).

In an embodiment, the second water-soluble polymer may include poly(meth)acrylamide or a copolymer including the same. In an embodiment, the copolymer may be a block copolymer or a random copolymer. In an embodiment of the present disclosure the copolymer may be a random copolymer which is polymerized by mixing two or more monomers together.

In an embodiment, the copolymer including poly(meth)acrylamide may be a copolymer including a (meth)acrylamide-based monomer polymerization unit; and a hydroxyl group-containing (meth)acrylate-based monomer polymerization unit, a polyfunctional (meth)acrylamide-based monomer polymerization unit, or a combination thereof.

The copolymer preferably includes, or is based on, a (meth)acrylamide-based monomer polymerization unit; or the copolymer includes a (meth)acrylamide-based monomer polymerization unit and a hydroxyl group-containing (meth)acrylate-based monomer polymerization unit; or the copolymer includes a (meth)acrylamide-based monomer polymerization unit, a hydroxyl group-containing (meth)acrylate-based monomer polymerization unit and a polyfunctional (meth)acrylamide-based monomer polymerization unit.

In an embodiment, the second water-soluble polymer is a copolymer including the (meth)acrylamide-based monomer polymerization unit, the hydroxyl group-containing (meth)acrylate-based monomer polymerization unit, and the polyfunctional (meth)acrylamide-based monomer polymerization unit. That is, since the separator according to an embodiment includes the copolymer, an electrolyte decomposition inhibition characteristic, heat resistance, and adhesion may be further improved.

In an embodiment, the (meth)acrylamide-based monomer polymerization unit may include a structure of the following Chemical Formula 1:

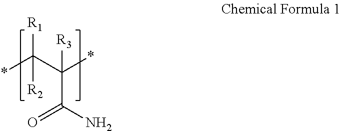

wherein R₁ to R₃ are independently of one another hydrogen, or substituted, or unsubstituted, linear or branched C1 to C6 alkyl group.

In an embodiment, the hydroxyl group-containing (meth)acrylate-based monomer polymerization unit may include a structure of the following Chemical Formula 2:

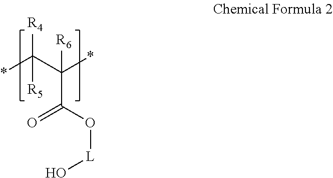

wherein R₄ to R₆ are independently of one another hydrogen or C₁ to C₆ alkyl group, and L is a C₁ to C₆ linear or branched alkylene group.

The polyfunctional (meth)acrylamide-based monomer polymerization unit may be produced by polymerizing a polyfunctional monomer represented by the following Chemical Formula 3:

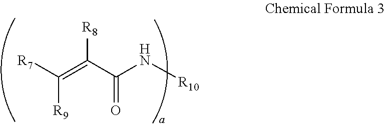

wherein R₇ to R₉ are independently of one another hydrogen, or substituted or unsubstituted, linear or branched C1 to C6 alkyl group, R₁₀ is a C1 to C10 linear or branched hydrocarbon group, and a is 2 to 6, preferably 2 or 3.

In the second water-soluble polymer according to an embodiment, the (meth)acrylamide-based monomer may be included at 65 to 98 mol % or 70 to 95 mol %. The hydroxyl group-containing (meth)acryl-based monomer may be included at 2 to 35 mol %, 3 to 30 mol %, or 5 to 25 mol %. The polyfunctional (meth)acrylamide-based monomer may be included at 0.001 to 1 mol % or 0.01 to 0.5 mol %. When the second water-soluble polymer is prepared within the content range, sufficient adhesive strength may be obtained, a more significant effect may be obtained at a shrinkage rate at a high temperature, and an electrolyte decomposition reaction may be effectively inhibited to further improve an effect of inhibiting a side reaction by a decomposition product of an electrolyte.

In an embodiment, the second water-soluble polymer may have a weight average molecular weight of 100,000 g/mol or more, 200,000 g/mol or more and 2,000,000 g/mol or less, 1,000,000 g/mol or less, 500,000 g/mol or less, or a value between the numerical values. Specifically, the second water-soluble polymer may have a weight average molecular weight of 100,000 to 2,000,000 g/mol, 200,000 to 1,000,000 g/mol, or 200,000 to 500,000 g/mol. According to an embodiment, when the weight average molecular weight of the second water-soluble polymer satisfies the above range, the electrolyte decomposition inhibition characteristic, the heat resistance, and the adhesion may be further improved. The weight average molecular weight is an average molecular weight in terms of polyethylene glycol measured using gel permeation chromatography.

The preparation method is not particularly limited as long as the second water-soluble polymer according to the embodiment described above may be provided, but in another embodiment, the second water-soluble polymer may be prepared by various known preparation methods such as emulsion polymerization, suspension polymerization, bulk polymerization, and solution polymerization.

In an embodiment, the second water-soluble polymer may be obtained by copolymerizing a mixture including the monomer components described above; and a polymerization initiator.

In an embodiment, the type of polymerization initiator is not particularly limited as long as the copolymer may be obtained, but in another embodiment, the polymerization initiator may be an azo-based initiator, a peroxide-based initiator, or a persulfate-based polymerization initiator such as potassium persulfate, sodium persulfate, or ammonium persulfate.

According to an embodiment, the second water-soluble polymer may be obtained by heating to 50 to 90° C. or 60 to 80° C., and then adding a polymerization initiator to perform a polymerization reaction.

In an embodiment, after the polymerization reaction is completed, the temperature is lowered to room temperature (20±5° C.), and a basic solution and the like are added to prepare a second water-soluble polymer aqueous solution adjusted to a neutral state.

In the separator, according to an embodiment, a content of the second water-soluble polymer may be 0.1 parts by weight or more, 0.5 parts by weight or more, 1 part by weight or more and 10 parts by weight or less, 5 parts by weight or less, 3 parts by weight or less, or a value between the numerical values, with respect to 100 parts by weight of the inorganic particles forming the inorganic particle layer. Specifically, the second water-soluble polymer may be included at 0.1 to 10 parts by weight, 0.5 to 5 parts by weight, or 1 to 3 parts by weight, with respect to 100 parts by weight of the inorganic particles. The separator according to an embodiment may have further improved electrolyte decomposition inhibition characteristics, heat resistance, and adhesion, when the content of the second water-soluble polymer satisfies the above range.

The separator according to an embodiment effectively inhibits the electrolyte decomposition reaction, and also simultaneously, has excellent heat resistance. According to an embodiment, heat shrinkage rates in MD and TD as measured after being allowed to stand at 150° C. for 60 minutes may be 2% or less, or 1.5% or less, preferably 1% or less, 0.8% or less, or 0.5% or less, and more preferably 0.3% or less or 0.2% or less.

In an embodiment, the porous substrate may be a polyolefin-based porous substrate such as polyethylene, polypropylene, or copolymers thereof, but is not limited thereto, and all porous substrates known as porous substrate of a separator of an electrochemical device may be used. In an embodiment, the porous substrate may be made of a film or sheet, but is not particularly limited thereto.

In an embodiment, the porous substrate may have a thickness of 1 μm or more, 3 μm or more, 5 μm or more and 100 μm or less, 50 μm or less, 30 μm or less, 20 μm or less, 15 μm or less, 12 μm or less, or a value between the numerical values, and 1 to 100 μm, specifically, for implementing a high capacity battery, 3 to 50 μm, more specifically 5 to 20 μm, and still more specifically 5 to 15 μm. Any suitable method may be used for making the porous substrate. As an example, the manufacturing process for making the porous substrate may include stretching a polymer film after the film is formed, e.g., by extrusion. Prior to the stretching the polymer film may be cooled to form a semicrystalline structure. Stretching may typically be performed at a temperature below the melting point of the polymer causing the crystalline regions to elongate and create voids, thus, forming a porous network. Following the porous structure formation the polymer film may be heat-treated to stabilize the pores and improve mechanical strength.

In an embodiment, the porous substrate may have a porosity of 20 to 60%, specifically 30 to 60%, but is not limited thereto. General weighing method is employed to calculate the porosity of the material. As weight (W), volume and density (p=0.95 g/cm³, fixed value) are familiar using these parameters we can calculate the porosity as follows: Vm=W/ρ. Consequently, we can calculate the volume of the pores (Vp) substituting total volume (Vt, cm³) and material volume (Vm) to next equation: Vp=Vt−Vm. Finally knowing Vp and Vt, we can get the Ø (porosity) using the formula below:

$$∅ = Vp / Vt * 100.$$

In an embodiment, the porous substrate may have a Gurley permeability of 50 sec/100 cc or more, 70 sec/100 cc or more and 100 sec/100 cc or less, 500 sec/100 cc or less, 200 sec/100 cc or less, 150 sec/100 cc or less, or a value between the numerical values, and 50 to 500 sec/100 cc, specifically 70 to 200 sec/100 cc, but is not limited thereto. Air permeability was measured in accordance with ASTM D726.

In an embodiment, the porous substrate may have a tensile strength in TD (transverse direction) and MD (machine direction) independently of each other of 1000 kgf/cm² or more, 1500 kgf/cm² or more and 5000 kgf/cm² or less, 4000 kgf/cm² or less, or a value between the numerical values, and 1000 to 5000 kgf/cm², specifically 1500 to 4000 kgf/cm², but is not limited thereto.

In an embodiment, the porous substrate may not substantially include a polar functional group on the surface. Since the separator according to an embodiment includes the porous substrate which does not substantially include a polar functional group on the surface, together with the specific polymer combination as described above, the electrolyte decomposition inhibition characteristic may be further improved. Herein, the porous substrate which w does not substantially include a polar functional group means the porous substrate which includes less than 1 wt % or less than 0.5 wt % of a polar functional group based on the total weight of the porous substrate. Specifically, the polar functional group may not be introduced to the porous substrate, since the porous substrate is not hydrophilically surface-treated. A non-limiting embodiment of the polar functional group may include a carboxyl group, an aldehyde group, a hydroxyl group, and the like, but is not particularly limited thereto. The hydrophilic surface treatment may be, according to an embodiment, a corona discharge treatment or a plasma discharge treatment.

In an embodiment, the inorganic particle layer may include a binder and inorganic particles, and may be a porous inorganic particle layer in which the inorganic particles are connected and fixed by the binder to form pores. In an embodiment, the inorganic particle layer is provided on at least one surface of the porous substrate, and may occupy an area fraction of 60% or more, 70% or more, 80% or more, or 90% or more, based on an overall surface of the porous substrate. Preferably, an inorganic particle layer may be applied on 100% of the area of the porous substrate.

In an embodiment, the inorganic particle layer may be coated on one or both surfaces of the porous substrate, and when both surfaces of the porous substrate are coated with the inorganic particle layer, the thicknesses of the inorganic particle layers coated on one surface and the other surface may be the same as or different from each other. Though it is not particularly limited, in an embodiment, the thickness of the inorganic particle layer coated on one surface may be 0.01 μm or more, 0.2 μm or more, 0.5 μm or more and 15 μm or less, 10 μm or less, 5 μm or less, or a value between the numerical values. In a specific embodiment, the inorganic particle layer may have a thickness of 0.01 μm to 15 μm, 0.2 μm to 10 μm, or 0.5 μm to 5 μm. We use the caliper thickness gauge to measure the thickness of a separator, where the separator is prepared by stacking 10 layers together. Five measurements at different points on the stacked separator is repeatedly recorded. After obtaining these measurements, calculate the average thickness value of the 10 layers separator from the five results to ensure the accuracy, and dividing the value by 10 again to derive an average thickness of the separator. The thickness of the inorganic particle layer was determined by subtracting the thickness of the porous substrate from the thickness of the separator. Wherein, the thickness of the porous substrate was calculated by stacking 10 layers of the porous substrate alone and performing the same method as for measuring the thickness of the separator.

In an embodiment, the inorganic particles are not limited as long as they are inorganic particles used in the art. A non-limiting embodiment of the inorganic particles may include one or two or more of metal hydroxides, metal oxides, metal nitrides, and metal carbides, or one or two or more of SiO₂, SiC, MgO, Y₂O₃, Al₂O₃, CeO₂, Cao, Zno, SrTiO₃, Zro₂, TiO₂, and AlO(OH). In view of battery stability and the like, the inorganic particles may be preferably metal hydroxide particles such as boehmite.

Though the metal hydroxide is not particularly limited, a non-limiting embodiment thereof may include one or two or more of boehmite, aluminum hydroxide, and magnesium hydroxide. In an embodiment, when the boehmite is used, for example, a specific surface area (BET) may be 10 m²/g or more or 15 m²/g or more, but the embodiment is not limited thereto.

In an embodiment, the inorganic particles may have an average diameter (D50) of 0.01 μm or more, 0.05 μm or more, 0.1 μm or more and 5 μm or less, 3 μm or less, 2 μm or less, 1 μm or less, or a value between the numerical values, and specifically, 0.01 μm to 5 μm, 0.05 μm to 3 μm, more specifically 0.05 μm to 2 μm, and still more preferably 0.1 μm to 1 μm.

An embodiment may provide a method for manufacturing a separator including preparing a slurry composition including a binder and inorganic particles; and applying the slurry composition on at least one surface of a porous substrate to form an inorganic particle layer, wherein the binder includes a first water-soluble polymer including a metal carboxylate group and a second water-soluble polymer based on (meth)acrylamide.

Hereinafter, each operation of a method for manufacturing a separator according to an embodiment will be described. Since the description of each of the porous substrate, the inorganic particle layer, the inorganic particles, the first water-soluble polymer, and the second water-soluble polymer is as described above, a detailed description will be omitted.

In the method of preparing a slurry composition, any common method known in the art may be applied without limitation, and though it is not particularly limited, according to a non-limiting embodiment, the inorganic particles may be dispersed by stirring to prepare a slurry, and agglomerated inorganic particles may be dispersed using a ball mill.

The slurry composition includes the inorganic particles, the first water-soluble polymer, the second water-soluble polymer, and a solvent. The solvent may be water, lower alcohols such as ethanol, methanol, and propanol, solvents such as dimethylformamide, acetone, tetrahydrofuran, diethylether, methylene chloride, DMF, N-ethyl-2-pyrrolidone, hexane, and cyclohexane, or a mixture thereof, but is not necessarily limited thereto.

In an embodiment, though a solid content of the slurry composition is not particularly limited, it may be, for example, 1 to 50 wt %, 5 to 30 wt %, or 10 to 30 wt %, but the embodiment is not limited thereto.

In an embodiment, the slurry composition may include 70 to 95 wt % of the inorganic particles, 1 to 20 wt % of the first water-soluble polymer, and 0.1 to 10 wt % of the second water-soluble polymer, and specifically, 80 to 95 wt % of the inorganic particles, 2 to 15 wt % of the first water-soluble polymer, and 0.5 to 5 wt % of the second water-soluble polymer, based on the total weight of the solid content, but the embodiment is not limited thereto.

In a method of applying the slurry composition, any common method known in the art may be applied without limitation, and according to a non-limiting embodiment, roll coating, spin coating, dip coating, bar coating, die coating, slit coating, inkjet printing, and a combination of these methods may be applied. The applied slurry may be dried and formed into an inorganic particle layer. Drying for forming the inorganic particle layer is not particularly limited, but may be performed at 100° C. or lower or 30 to 60° C.

In a specific embodiment, after performing drying for forming the inorganic particle layer, a process of aging the porous substrate having the inorganic particle layer formed thereon may be further included. Specifically, the aging may be performed at 50 to 150° C. or 60 to 120° C., and an aging time may be 2 hours to 24 hours or 10 to 20 hours. More specifically, the aging may be performed in a temperature range of 70 to 120° C. for 10 to 15 hours. The aging may increase adhesion between the porous substrate and the inorganic particle layer, and further improve heat resistance at a high temperature.

According to an embodiment, an electrochemical device including the separator according to an embodiment described above may be provided. The electrochemical device may have reduced electrical resistance by including the separator as described above, and also significantly improved life characteristics.

The electrochemical device may be any suitable type, including known energy storage devices, and though it is not particularly limited, it may be a lithium secondary battery. Since the lithium secondary battery is well known and its configuration is also known, it will not described in detail in the present disclosure.

The lithium secondary battery according to an embodiment may include the separator described above between a positive electrode and a negative electrode. Herein, the positive electrode and the negative electrode may be used without limitation as long as they are commonly used in the lithium secondary battery.

When the separator according to an embodiment is commonly used in a secondary battery, the manufacturing method follows a common manufacturing method in which a negative electrode, a separator, and a positive electrode are arranged and assembled, and an electrolyte solution is injected thereto to complete the manufacture, and thus, the manufacturing method will not be described any more in detail.

Hereinafter, embodiments and experimental examples will be illustrated in detail. However, the embodiments and the experimental examples described later are only a partial illustration, and the technology described in the present specification is not construed as being limited thereto.

First, methods of evaluating the characteristics of the separator and the secondary battery will be described.

### Weight Average Molecular Weight

The weight average molecular weight was measured using GPC (Tosoh, EcoSEC HLC-8320 GPC Reflective Index detector). Tskgel guard PWx, two TSKgel GMPWxls, and TSKgel G2500PWx1 (7.8×300 mm) were used as a GPC column, a 0.1 M NaNO3 aqueous solution was used as a solvent, polyethylene glycol was used as a standard, and analysis was performed at 40° C. at a flow rate of 1 ml/min.

### Electrolyte Decomposition Inhibition Characteristic of Separator

In order to evaluate the electrolyte decomposition inhibition characteristic of the separator, 0.8 g of a separator which was in a state of being impregnated in 10 g of an electrolyte in which 1 M lithium hexafluorophosphate (LiPF₆) was dissolved in a solution of ethylene carbonate (EC), ethyl methyl carbonate (EMC), and dimethyl carbonate (DMC) at a volume ratio of 30:50:20 was stored in an oven set to 60° C. for 10 days. Thereafter, the electrolyte in which the separator was impregnated was analyzed by 19F NMR analysis to confirm a degree of the produced decomposition product of the electrolyte represented by a phosphine by-product and HF. Specifically, in order to quantify the electrolyte decomposition inhibition characteristics, an integral value of the peak of HF in the 19F NMR analysis spectrum was calculated to measure the HF content.

### Heat Shrinkage Rate of Separator

The heat shrinkage rate of the separator was measured based on ASTM D 1204, by the following method. Grid points were marked at 2 cm intervals on a square having sides of 10 cm on a separator. One side of the square was the transverse direction (TD) and the other side of the square was the machine direction (MD). A specimen was placed in the center, 5 sheets of paper were placed on and under the specimen, and the four sides of the paper were wrapped with tape. The specimen wrapped in paper was allowed to stand in a hot air drying oven at 150° C. for 60 minutes. Thereafter, the specimen was taken out, the separator was observed with a camera, and the shrinkage rate in the machine direction of the following Equation 1 and the shrinkage rate in the width direction of the following Equation 2 were calculated.

$$Shrinkage rate in machine direction ( \% ) = \{ ( length in machine direction before heating - length in machine direction after heating ) / length in machine direction before heating \} \times 100 \qquad Equation 1$$

$$Shrinkage rate in width direction ( \% ) = \qquad Equation 2$$

$$\{ ( length in width direction before heating -$$

$$length in width direction after heating ) /$$

$$length in width direction before heating \} \times 100$$

### Adhesion of Separator

A separator was cut into a size of 50 mm wide×50 mm long and placed so that the inorganic particle layer was on top. A piece of black drawing paper (20 mm wide×150 mm long×0.25 mm thick) having a coefficient of dynamic fraction of 0.15 was placed thereon, a pressing device was used to apply a certain pressure (200 g/cm²), the black drawing paper was forcibly pulled to the side, and a degree of inorganic material adhered on the surface was confirmed and determined as A/B/C/D/E/F depending on the adhesion degree, referring to the following grade:
A: no adhesion
B: inorganic material adhered in a small amount

In C-F, the binder and the inorganic material were adhered together and the degree was severe toward F.

### Initial Performance of Secondary Battery

In order to evaluate the initial performance of the secondary batteries manufactured according to each example and comparative example, resistance and discharge output of the secondary battery were measured by the following method, e and the performance of the batteries of the remaining examples and comparative examples was relatively evaluated based on Comparative Example 1.

The secondary battery was charged at 0.5 C CC/CV (4.2 V 0.05 C CUT-OFF) at 25° C., and then a battery thickness was measured.

The secondary battery was charged to 4.2 V, 0.05 C with a constant current-constant voltage (CC-CV) using a charge/discharge cycle device at room temperature, and then discharged to 2.7 V at a current of 0.5 C. Then, direct current internal resistance (DC-IR) was measured at 60% of state of charge (SOC) by a J-pulse method.

The output characteristics of the secondary battery at a state of charge of 50% at room temperature were measured by a hybrid pulse power characterization by FreedomCar battery test manual (HPPC) method.

### Life Characteristics

The secondary battery manufactured according to each of the examples and the comparative examples was charged at a constant current-constant voltage (CC-CV) of 4.2 V using a charge/discharge cycle device, and then discharged. The secondary battery was charged at constant current with a 0.5 C rate at 25° C. until the voltage reached 4.2 V, and charged at constant voltage until the current was 0.01 C while maintaining 4.2 V. Subsequently, a cycle of discharging at a constant current of 0.5 C until the voltage reached 3.0 V during discharging was repeated 800 times. As the resistance, direct current internal resistance (DC-IR) was measured by a J-pulse method, and then a resistance increase rate (ΔR) was calculated by the following equation. The values of the remaining examples and comparative examples were relatively evaluated based on Comparative Example 1, and the lower the numerical value, the lower the relative resistance increase rate.

$$Δ R ( \% ) = ( {R}_{2} - {R}_{1} ) / {R}_{1} \times 100$$

wherein R₁ is initial resistance (mΩ) measured after a first cycle of each manufactured battery, and R₂ is resistance (m2) after 800 cycles.

In addition, a capacity retention rate (ΔC) was calculated according to the following equation, and likewise, the values of the remaining examples and comparative examples were relatively evaluated based on Comparative Example 1. The higher the numerical value, the higher the relative capacity retention rate.

$$Δ C ( \% ) = ( {C}_{2} - {C}_{1} ) / {C}_{1} \times 100$$

wherein C₁ is an initial discharge capacity (Ag) measured after a first cycle of each manufactured battery, and C2 is a discharge capacity (Ag) after 800 cycles.

### Storage Stability at High Temperature

The secondary battery manufactured according to each of the examples and the comparative examples was stored in an oven at 60° C. for 80 days, and then direct current internal resistance (DC-IR) and discharge capacity were measured by the J-pulse method described above. Thereafter, the resistance increase rate (ΔR′) and the capacity retention rate (ΔC′) were calculated according to the following equations, respectively, and the values of the remaining examples and comparative examples were relatively evaluated based on Comparative Example 1. The lower the numerical value, the lower the relative resistance increase rate, and the higher the numerical value, the higher the relative capacity retention rate.

$$Δ {R}^{′} ( \% ) = ( {R}_{4} - {R}_{3} ) / {R}_{3} \times 100$$

wherein R³ is initial resistance (mΩ) before storing each manufactured battery in an oven, and R4 is resistance (mΩ) after storing in an oven at 60° C. for 80 days.

$$Δ {C}^{′} ( \% ) = ( {C}_{4} - {C}_{3} ) / {C}_{3} \times 100$$

wherein C3 is discharge capacity (Ag) before storing each manufactured battery in an oven, and C4 is discharge capacity (Ah) after storing in an oven at 60° C. for 80 days.

### Preparation Example 1

The inside of a 1.0 L flask was replaced with nitrogen, 1055 mmol of acrylamide as a monomer component and 700 g of distilled water were added to the flask, and heating to 75° C. was performed. Thereafter, 0.789 mmol of ammonium persulfate as a polymerization initiator was further added to the flask, the flask was closed, and a polymerization reaction of the mixture proceeded. After the polymerization reaction was performed for 12 hours, the closed flask was opened to the air to lower the temperature to room temperature, and a 1M sodium hydroxide solution was added to adjust the pH to 7, thereby preparing a second water-soluble polymer aqueous solution. At this time, the prepared second water-soluble polymer had a weight average molecular weight of 280,000 g/mol.

### Preparation Example 2

A second water-soluble polymer aqueous solution was prepared in the same manner as in Preparation Example 1, except that 878 mmol of acrylamide as the monomer component and 204 mmol of 2-hydroxyethylmethacrylamide were used. At this time, the prepared second water-soluble polymer had a weight average molecular weight of 300,000 g/mol.

### Preparation Example 3

A second water-soluble polymer aqueous solution was prepared in the same manner as in Preparation Example 1, except that 932 mmol of acrylamide as the monomer component, 89 mmol of 2-hydroxyethylmethacrylate, and 0.324 mmol of N′-methylenebisacrylamide were used. At this time, the prepared second water-soluble polymer had a weight average molecular weight of 250,000 g/mol.

### Example 1

### Preparation of Slurry Composition

90.35 wt % of boehmite (γ-AlO(OH)) having an average particle diameter (D50) of 0.6 μm, 8.64 wt % of a sodium polyacrylate salt (Sigma-aldrich, Mw: 5,100 g/mol), and 1.01 wt % of the second d water-soluble polymer prepared in Preparation Example 1, based on the total weight of the solid content were added to water, and then stirring was performed to prepare a slurry composition having a solid content concentration of 25 wt %.

### Manufacture of Separator

A polyethylene porous film (porosity: 48%, Gurley permeability: 82 sec/100 cc, tensile strength in MD: 2020 kgf/cm², tensile strength in TD: 1950 kgf/cm²) having a thickness of 9 μm was used as a porous substrate. Both surfaces of the porous substrate were coated with the slurry composition prepared above without a surface treatment to form an inorganic particle layer having a thickness of 2.0 μm, respectively. The porous substrate on which the inorganic particle layer was prepared was aged at 80° C. for 12 hours to manufacture a separator. The characteristics of the separator are listed in the following Table 1.

### Manufacture of Secondary Battery

94 wt % of LiCoO₂ as a positive electrode active material, 2.5 wt % of polyvinylidene fluoride as a fusing agent, and 3.5 wt % of carbon black as a conductive agent were added to N-methyl-2-pyrrolidone (NMP) as a solvent, and stirring was performed to prepare a uniform positive electrode slurry. The positive electrode slurry prepared above was coated on an aluminum foil having a thickness of 30 μm, dried, and pressed to manufacture a positive electrode having a total thickness of 150 μm. 95 wt % of artificial graphite as a negative electrode active material, 3 wt % of acryl-based latex having Tg of −52° C. as a fusing agent, and 2 wt % of carboxymethyl cellulose (CMC) as a thickener were added to water as a solvent, and stirring was performed to prepare a uniform negative electrode slurry. The negative electrode slurry prepared above was coated on a copper foil having a thickness of 20 μm, dried, and pressed to manufacture a negative electrode having a total thickness of 150 μm. The positive electrode, the negative electrode, and the separator manufactured above were assembled into a pouch type battery so that the separator was stacked between the positive electrode and the negative electrode, and the assembled battery was heat-fused at 80° C. and 1 MPa with a heat press machine so that the positive electrode, the negative electrode, and the separator were fused to each other. Thereafter, an electrolyte in which 1 M lithium hexafluorophosphate (LiPF₆) was dissolved in a solution including ethylene carbonate (EC), ethyl methyl carbonate (EMC), and dimethyl carbonate (DMC) at a volume ratio of 30:50:20 was injected, and the battery was sealed to manufacture a secondary battery having a capacity of 2 Ah. The initial performance, the life characteristics, and the storage stability at a high temperature of the secondary battery are listed in the following Table 2.

### Example 2

A separator and a secondary battery were manufactured in the same manner as in Example 1, except that 94.05 wt % of boehmite, 4.91 wt % of a sodium polyacrylate salt, and 1.05 water-soluble polymer prepared in wt % of the second Preparation Example 1 were used based on the total weight of the solid content to prepare a slurry composition having a solid content concentration of 25 wt %. The characteristics of the separator and the secondary battery are listed in the following Tables 1 and 2.

### Example 3

A separator and a secondary battery were manufactured in the same manner as in Example 2, except that the second water-soluble polymer prepared in Preparation Example 2 was used instead of the second water-soluble polymer prepared in Preparation Example 1. The characteristics of the separator and the secondary battery are listed in the following Tables 1 and 2.

### Example 4

A separator and a secondary battery were manufactured in the same manner as in Example 2, except that the second water-soluble polymer prepared in Preparation Example 3 was used instead of the second water-soluble polymer prepared in Preparation Example 1. The characteristics of the separator and the secondary battery are listed in the following Tables 1 and 2.

### Comparative Example 1

### Preparation of Slurry Composition

97 wt % of boehmite (γ-AlO(OH)) having an average particle diameter (D50) of 0.6 μm and 3 wt % of the second water-soluble polymer prepared in Preparation Example 1 based on the total weight of the solid without using the sodium polyacrylate salt were added to water, and then stirring was performed to prepare a slurry having a solid content concentration of 25 wt %.

### Manufacture of Separator

A polyethylene porous (porosity: 48%, Gurley permeability: 82 sec/100 cc, tensile strength in MD: 2020 kgf/cm², tensile strength in TD: 1950 kgf/cm²) having a thickness of 9 μm was used as a porous substrate. Both surfaces of the porous substrate were corona discharge treated (power density: 2 W/mm) to introduce a surface polar group, and the corona discharge treatment was performed at a speed of 3 to 20 mpm (meter per minute). Both surfaces of the porous substrate to which the surface polar group was introduced were coated with the slurry composition prepared above to form an inorganic particle layer having a thickness of 2.0 μm, respectively. The porous substrate on which the inorganic particle layer was prepared was aged at 80° C. for 12 hours to manufacture a separator. The characteristics of the separator are listed in the following Table 1.

### Manufacture of Secondary Battery

A secondary battery was manufactured in the same manner as in Example 1, except that the separator manufactured above was used. The characteristics of the secondary battery are listed in the following Table 2.

### Comparative Example 2

A separator and a secondary battery were manufactured in the same manner as in Comparative Example 1, except that the second water-soluble polymer prepared in Preparation Example 3 was used instead of the second water-soluble polymer prepared in Preparation Example 1. The characteristics of the separator and the secondary battery are listed in the following Tables 1 and 2.

### Comparative Example 3

A slurry composition, a separator, and a secondary battery were manufactured in the same manner as in Example 1, except that polyvinyl alcohol (Sigma-Aldrich, Mw: 180,000 g/mol) was used instead of the second water-soluble polymer of Preparation Example 1. The characteristics of the separator and the secondary battery are listed in the following Tables 1 and 2.

### Comparative Example 4

A slurry composition, a separator, and a secondary battery were manufactured in the same manner as in Example 1, except that polyvinylpyrrolidone (Sigma-Aldrich, Mw: 55,000 g/mol) was used instead of the second water-soluble polymer of Preparation Example 1. The characteristics of the separator and the secondary battery are listed in the following Tables 1 and 2.

TABLE 1

| | HF content | Heat shrinkage rate (%) | | Strawboard |
|---|---|---|---|---|
| | (ppm) | MD | TD | adhesive strength |
| Example 1 | 121 | 1.4 | 0.9 | A |
| Example 2 | 180 | 1.5 | 1.1 | A |
| Example 3 | 181 | 0.4 | 0.5 | A |
| Example 4 | 178 | 0.2 | 0.1 | A |
| Comparative | 421 | 3 | 2.5 | B |
| Example 1 | | | | |
| Comparative | 415 | 2.6 | 1.8 | B |
| Example 2 | | | | |
| Comparative | 612 | 6.2 | 4.5 | A |
| Example 3 | | | | |
| Comparative | 430 | 7.5 | 4.5 | B |
| Example 4 | | | | |

TABLE 2

| | | | Life characteristics | | Storage stability at high temperature | |
|---|---|---|---|---|---|---|
| | Initial performance | | Capacity | Resistance | Capacity | Resistance |
| | DCIR | Discharge output | retention rate | increase rate | retention rate | increase rate |
| | (mΩ) | (W/kg) | (%) | (%) | (%) | (%) |
| Example 1 | Equivalent | Higher by 1.0% | Higher by 4.4% | Lower by 4.3% | Higher by 2.6% | Lower by 5.1% |
| Example 2 | Lower by 1.9% | Higher by 2.0% | Higher by 4.6% | Lower by 8.7% | Higher by 8.6% | Lower by 17.4% |
| Example 3 | Lower by 2.1% | Higher by 2.2% | Higher by 4.7% | Lower by 9.5% | Higher by 8.2% | Lower by 17.4% |
| Example 4 | Lower by 2.2% | Higher by 2.6% | Higher by 4.6% | Lower by 9.9% | Higher by 8.7% | Lower by 17.5% |
| Comparative | Standard | Standard | Standard | Standard | Standard | Standard |
| Example 1 | | | | | | |
| Comparative | Equivalent | Equivalent | Higher by 1.1% | Lower by 0.7% | Higher by 1.1% | Lower by 0.5% |
| Example 2 | | | | | | |
| Comparative | Higher by 0.7% | Lower by 1.2% | Lower by 3.5% | Higher by 5.1% | Lower by 2.5% | Higher by 3.3% |
| Example 3 | | | | | | |
| Comparative | Equivalent | Equivalent | Lower by 1.5% | Higher by 0.6% | Lower by 0.7% | Higher by 1.3% |
| Example 4 | | | | | | |

Referring to Tables 1 and 2, since the separators of Examples 1 to 4 included the first water-soluble polymer and the second water-soluble polymer according to an embodiment as a binder, it was confirmed that the electrolyte 5 decomposition reaction was effectively inhibited, heat shrinkage rates in MD and TD were 1.5% or less as measured after being allowed to stand at 150° C. for 60 minutes, which means excellent heat resistance, and a strawboard adhesive strength was A, which means significantly improved adhesion, as compared with the separators of Comparative Examples 1 to 4. In addition, since the secondary batteries of Examples 1 to 4 included the separator according to an embodiment, it was confirmed that initial performance, life characteristics, and stability at a high temperature were all improved.

In addition, since the batteries of Examples 2 to 4 used 1 to 9 parts by weight of the first water-soluble polymer based on 100 parts by weight of the inorganic particles, they were confirmed to have better performance.

In addition, since Examples 3 and 4 used the second water-soluble polymer prepared by further including the hydroxyl group-containing (meth)acrylate-based monomer and/or polyfunctional (meth)acrylamide-based monomer in addition to the (meth)acrylamide-based monomer, as a binder, they showed better electrolyte decomposition inhibition characteristic, heat resistance, and adhesion, and the batteries to which the separators were applied also showed better initial performance, life characteristics, and stability at a high temperature,

However, Comparative Examples 1 and 2 did not use the sodium polyacrylate salt as a binder, and thus, were confirmed to have deteriorated heat resistance as compared with the examples, excessive occurrence of electrolyte decomposition by-products, and increased gassing due to electrolyte decomposition, so that the initial performance, the life characteristics, and the stability at a high temperature of the battery were deteriorated.

Comparative Examples 3 and 4 used a type of polymer other than the polyacrylamide-based polymer as the binder, and thus, were confirmed to have the initial performance, the life characteristics, and the stability at a high temperature of the secondary battery as well as the electrolyte decomposition inhibition characteristic, the heat resistance, and the adhesion of the separator which were all deteriorated as compared with the examples.

Since the separator according to an embodiment of the present disclosure includes a combination of specific water-soluble polymers, it may effectively inhibit the electrolyte decomposition reaction to improve performance of an electrochemical device, and also simultaneously, may secure excellent heat resistance and adhesion.

Since the electrochemical device according to an embodiment includes the separator described above, it may have a characteristic of decreased electrochemical device volume change, and also, have reduced resistance to have a significantly excellent life characteristic.

Hereinabove, although the embodiments of the present disclosure have been described by specific examples, it is noted that these examples have been provided only for assisting the entire understanding of the present disclosure, and that the embodiments of the present disclosure are not limited to the described embodiments, and various modifications and changes may be made by those skilled in the art to which the present disclosure pertains from the description. Furthermore, the embodiments may be combined to form additional embodiments.

What is claimed is:

1. A separator comprising:
a porous substrate; and
an inorganic particle layer which is formed on at least one surface of the porous substrate, the inorganic particle layer including a binder and inorganic particles,
wherein the binder includes a first water-soluble polymer including a metal carboxylate group and a second water-soluble polymer based on (meth)acrylamide.

2. The separator of claim 1,
wherein the first water-soluble polymer is one or more selected from the group consisting of polyacrylic acid metal salts, carboxymethylcellulose metal salts, and alginic acid metal salts, and
the metal includes an alkali metal, an alkaline earth metal, or a combination thereof.

3. The separator of claim 1, wherein the first water-soluble polymer has a weight average molecular weight of 2,000 to 100,000 g/mol.

4. The separator of claim 1, wherein 1 to 20 parts by weight of the first water-soluble polymer is included with respect to 100 parts by weight of the inorganic particles.

5. The separator of claim 1, wherein the second water-soluble polymer is poly(meth)acrylamide or a copolymer including the same.

6. The separator of claim 5, wherein the copolymer is a copolymer including a (meth)acrylamide-based monomer polymerization unit; and a hydroxyl group-containing (meth)acrylate-based monomer polymerization unit, a polyfunctional (meth)acrylamide-based monomer polymerization unit, or a combination thereof.

7. The separator of claim 1, wherein the second water-soluble polymer has a weight average molecular weight of 100,000 to 2,000,000 g/mol.

8. The separator of claim 1, wherein 0.1 to 10 parts by weight of the second water-soluble polymer is included with respect to 100 parts by weight of the inorganic particles.

9. The separator of claim 1, wherein heat shrinkage rates in machine direction (MD) and transverse direction (TD) are 2% or less as measured after the separator is allowed to stand at 150° C. for 60 minutes.

10. A method for manufacturing a separator, the method comprising:
preparing a slurry composition including a binder and inorganic particles; and
applying the slurry composition on at least one surface of a porous substrate to form an inorganic particle layer,
wherein the binder includes a first water-soluble polymer including a metal carboxylate group and a second water-soluble polymer based on (meth)acrylamide.

11. The method for manufacturing a separator of claim 10,
wherein the first water-soluble polymer is one or more selected from the group consisting of polyacrylic acid metal salts, carboxymethylcellulose metal salts, and alginic acid metal salts, and
the metal includes an alkali metal, an alkaline earth metal, or a combination thereof.

12. The method for manufacturing a separator of claim 10, wherein the first water-soluble polymer has a weight average molecular weight of 2,000 to 100,000 g/mol.

13. The method for manufacturing a separator of claim 10, wherein the second water-soluble polymer is polyacrylamide or a copolymer including the same.

14. The method for manufacturing a separator of claim 13, wherein the copolymer is a copolymer including a (meth)acrylamide-based monomer polymerization unit; and a hydroxyl group-containing (meth)acrylate-based monomer polymerization unit, a polyfunctional (meth)acrylamide-based monomer polymerization unit, or a combination thereof.

15. An electrochemical device comprising the separator of claim 1.
